(19) United States
(12) Patent Application Publication
(10) Pub. No.: US 2016/0148223 A1
(43) Pub. Date: May 26, 2016

(54) FORECASTING WEB METRICS USING STATISTICAL CAUSALITY BASED FEATURE SELECTION

(71) Applicant: ADOBE SYSTEMS INCORPORATED, SAN JOSE, CA (US)

(72) Inventors: SHIV KUMAR SAINI, BAGAR (IN); SURYA PRATAP SINGH TANWAR, HAWA SARAK (IN); TUSHAR MEHNDIRATTA, RAJPURA TOWN (IN); DHRUV ANAND, BANDRA (IN)

(21) Appl. No.: 14/550,146

(22) Filed: Nov. 21, 2014

(51) Int. Cl. G06Q 30/02; G06Q 10/06

(52) U.S. Cl. CPC G06Q 30/0202; G06Q 10/067

(57) ABSTRACT

Embodiments of the present invention relate to forecasting metrics, such as web metrics, using causality-based feature selection. In embodiments, a set of potential features from which to generate a forecasting model is referenced. The set of potential features includes lags of observed features. A subset of features is selected, from among the potential features, that causally relate to a target web metric for which a forecast is desired. The selected subset of features causally related to the target web metric is used to generate the forecasting model. Such a forecasting model can be used to forecast an outcome associated with the target web metric.

### BACKGROUND

Forecasting is frequently performed to discover or predict useable information and to support decision making. Many businesses rely on forecasting to improve performance and/or quality. For example, modern web analytic services can measure and report data associated with hundreds of metrics for an online service(s). The captured data can be used to forecast or predict a metric of interest(s), such as an expected value of revenue at a time in the future. An accurate forecast can better enable anticipation of future revenue, for instance, that might be lower than expected such that any necessary actions can be taken to improve revenue potential.

Generating an accurate forecast, however, can be a challenging task. In particular, in addition to the large quantity (e.g., thousands) of data that might be tracked and available for use in forecasting, much of the data may be spuriously correlated with a metric being forecasted. Spurious correlation occurs when data are correlated but have no causal connection. Spurious correlation may result, for instance, when captured data depend on a common external factor(s) (e.g., weather) that results in a high correlation therebetween, but the correlation is not necessarily causally related or relevant. Utilizing spurious correlations to generate a forecasting model can result in a forecasting model that provides a less accurate forecast. Further, as relationships between data can be highly dynamic, forecasting accuracy may also fluctuate.

### SUMMARY

Embodiments of the present invention relate to generating forecasting models using causality-based feature selection. That is, features causally related to a metric of interest to be forecasted are selected for use in generating a forecasting model. In this regard, utilization of features spuriously correlated to a target metric to generate a forecasting model is reduced or eliminated. Selecting features that are causally correlated with a metric to be forecasted can generate a more accurate forecast. As described herein, the concept of Granger Causality can be utilized to select a set of features causally related to a metric of interest. In some embodiments, the Granger Causality concept is combined with a feature selection technique, such as a multivariate modeling approach (e.g., Least Absolute Shrinkage and Selection Operator), to select features for use in generating a forecasting model. In such embodiments, applying a feature selection technique can reduce the number of features to use in generating a forecasting model while Granger Causality assures causality to the metric of interest.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary web analytics environment suitable for use in implementing embodiments of the present invention;

FIG. 2 is a block diagram of an exemplary computing environment suitable for use in implementing embodiments of the present invention;

FIG. 3 depicts an exemplary data matrix, according to embodiments of the present invention;

FIG. 4 depicts an exemplary flow diagram illustrating a method for generating forecasting models using causality-based feature selection, in accordance with embodiments of the present invention;

FIG. 5 is an exemplary flow diagram illustrating another method for generating forecasting models using causality-based feature selection, in accordance with embodiments of the present invention;

FIG. 6 is an exemplary flow diagram illustrating a method for tracking a forecasting model, according to embodiments of the present invention; and

FIG. 7 is a block diagram of an exemplary operating environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

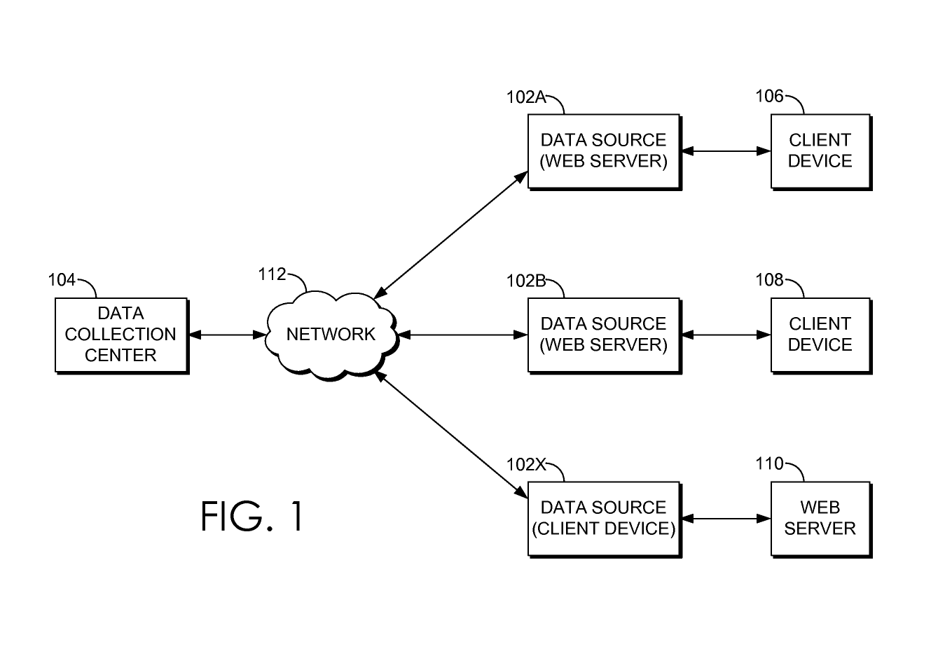

Oftentimes, data collected at a data collection center, such as the data collection center 104 of FIG. 1, is utilized to forecast a metric of interest or a target metric. A target metric or metric of interest generally refers to any type of measurement used to indicate or gauge some quantifiable component of data for which a forecast is desired. Oftentimes, a metric is related to performance, but is not intended to be limited herein. By way of example, and without limitation, a metric may be a type of measurement related to marketing or performance, such as an offer shown, an offer touched or viewed, an offer redeemed, a conversion, website visits, visit time, etc.

Accurate forecasting of a target metric is invaluable to those utilizing the data to make decisions. With an extensive quantity of data that may be captured and analyzed, however, accurate forecasting can be difficult. In particular, selecting a set of features to utilize in generating a forecasting model can be difficult as a large number of potential features may exist. A feature generally refers to a variable (e.g., attribute, regressor, input, or factor) including a lag variable (associated with a past value) that is a characteristic of a unit being observed or measured. A feature may be represented by a column in a data matrix, for example. In addition to an extensive set of potential features, utilizing spuriously correlated data to generate a forecasting model can result in a less effective forecast. That is, using a feature(s) having no causal connection to a target metric to generate a forecasting model can impact the accuracy of a forecast.

As using an appropriate set of features to generate a forecasting model can provide more accurate forecasting results, embodiments of the present invention are directed to generating forecasting models using causality-based feature selection. Causality-based feature selection refers to selecting features, from among a set of features, that are causally related to the metric to be forecasted. In this regard, utilization of features spuriously correlated to a target metric to generate a forecasting model is reduced or eliminated. Selecting features that are causally correlated with a metric to be forecasted can generate a better forecast.

Prior approaches for feature selection have used correlation rather than causality to select features. Causality or a causal relationship is directed to a cause and effect relationship between a selected feature and a metric to be predicted as opposed to simply a correlation of data. As an example, website visits to a particular site may tend to be higher on the weekends and the number of individuals going to the beach on the weekend may also be high. As such, the correlation between the two events may be high, but not relevant to one another or a cause/effect relationship. Based on the strong correlation between the two events, prior approaches to predict future website visits may result in feature selection and utilization of “beach visits,” which may ultimately result in a less effective forecasting model. Utilizing a causality-based feature selection approach, on the other hand, the spuriously correlated feature of “beach visits” would not be selected for use in generating a forecasting model as a causal relationship does not exist between “beach visits” and “website visits.” Instead, only features that are causally related to the metric to be forecasted (website visits) are selected for use in generating the forecasting model.

As described herein, the concept of Granger Causality can be utilized to select features causally related to a metric of interest. Prior use of Granger Causality has been limited to determining whether a variable causes a result. Aspects of the present invention utilize Granger Causality in the context of selecting features for a forecasting model, and particularly, forecasting models used in a web analytics environment. In this regard, Granger Causality can be applied to differentiate between features causally connected to the metric of interest rather than features merely correlated to the metric of interest. In some embodiments, the Granger Causality concept is combined with a feature selection technique, such as a multivariate modeling approach, to select features for use in generating a forecasting model. A multivariate modeling approach can be used to identify relationships between features. In this regard, a multivariate modeling approach can be used to select a best subset of explanatory time series out of a large set of time series. As described in more detail below, using a multivariate modeling approach, such as Least Absolute Shrinkage and Selection Operator (LASSO), can facilitate selection of highly correlated features while addressing multicollinearity, namely, multiple features in a multiple regression model that are highly correlated to one another. Upon using LASSO to reduce or select a specific set of features, Granger Causality can be used to identify features causally related to a target metric. Such causally related features can then be used to generate a forecasting model.

Upon generating a forecasting model using features selected based on causality correlation to a forecasted metric, the forecasting model can be used to forecast a metric. As relationships among features may change over time, the forecasting model can be tracked over time to verify its accuracy. When relationship changes are significant or exceed a threshold, the forecasting model can be regenerated. Tracking a forecasting model can enable recognition and correction of outdated forecasting models. As such, a more accurate forecasting model can be generated and implemented to forecast a metric of interest.

Accurate forecasting is invaluable in many environments. For example, in an exemplary environment of web analytics, accurate forecasting is desirable for any number of analyses performed on data associated with website traffic. Web analytics can include, for example, capturing data on website usage. In this regard, a variety of website traffic data can be measured including the type of browser being used, links selected on a particular web page, conversions, page visits, etc. Such website traffic data can then be used to forecast any number of metrics related to the web (web metrics), such as revenue, website visits, web purchases, clicks, etc.

To assist in the collection and analysis of online analytics data, some web analysis tools, such as the ADOBE SITECATALYST tool, have been developed that provide mechanisms to collect information regarding website usage and to manage analysis of the collected data. With such tools, metrics can be more accurately forecasted resulting in more useful information being provided to users of the tools. Further, due to the unwieldy amounts of data collected, efficient generation and tracking of forecasting models is desirable.

An exemplary web analytics environment is illustrated in FIG. 1. A data collection center 104 associated with a forecasting tool (not shown) is used to collect a large amount of web data available via the World Wide Web, which may include any number of web services or sites. The amount of data available is extremely large, and it may be impractical or burdensome for the website provider to collect and/or analyze such data. As such, a data collection center associated with a forecasting tool can collect web site visitors' online analytics data such as page views and visits that are relevant to a web site(s).

Such a large amount of web data results, in part, from the numerous data sources providing web data. With continued reference to FIG. 1, in one embodiment, each of the data sources 102A, 102B, and 102X provide a data collection center 104 with data describing web traffic. Each of data sources 102A, 102B, and 102X is a data source, such as a web server or a client device, capable of providing data associated with website usage, for example, via a network 112. For instance, data source 102A might be a web server associated with a website, data source 102B might be a web server associated with the website, and data source 102X might be a client device being used to navigate the website via a browser.

As illustrated in FIG. 1, data source 102A and data source 102B can obtain web data based on interactions with the respective client devices 106 and 108. In this regard, the browsers of the client devices can request web pages from the corresponding web servers and, in response, the web servers return the appropriate HTML page to the requesting client devices. Web data detected from navigations of the corresponding web pages at client devices 106 and 108 can be obtained at the web servers 102A and 102B and provided to the data collection center 104 via the network 112. By comparison, data source 102X can be a client device having a browser that requests a web page from a web server 110. The web server 110 can return to the client device 102X the appropriate HTML page with code (e.g., JavaScript code) that triggers communication of the web data to the data collection center 104 via the network 112.

Although FIG. 1 illustrates data sources as including both web servers and client devices, in some embodiments, such data sources might be solely web servers or solely client devices. Further, as can be appreciated, the web data provided to the data collection center 104 from the data sources can be associated with any number of web sites. For instance, in some cases, each of the data sources might provide data associated with a single web site (e.g., various clients navigating a particular web site). In other cases, the data sources might provide web data associated with multiple web sites (e.g., web servers associated with various web sites).

While FIG. 1 is generally described herein in reference to a web analytics environment, data collection may occur in any number of environments including any other web or non-web related environment. Irrespective of the environment, the data collection center 104 can collect data from any number of data sources and in any manner.

As will be discussed in further detail below, a forecasting tool can be used to generate, utilize, and track a forecasting model. The forecasting tool can perform such functionality in association with any amount of numerical data. Further, the model generation and/or forecasting functionality described herein can be applied to data associated with any type of subject matter, such as, for example, shopping data, text document data, advertisement targeting data, or the like.

Having briefly described an overview of embodiments of the present invention, a block diagram is provided illustrating an exemplary system 200 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

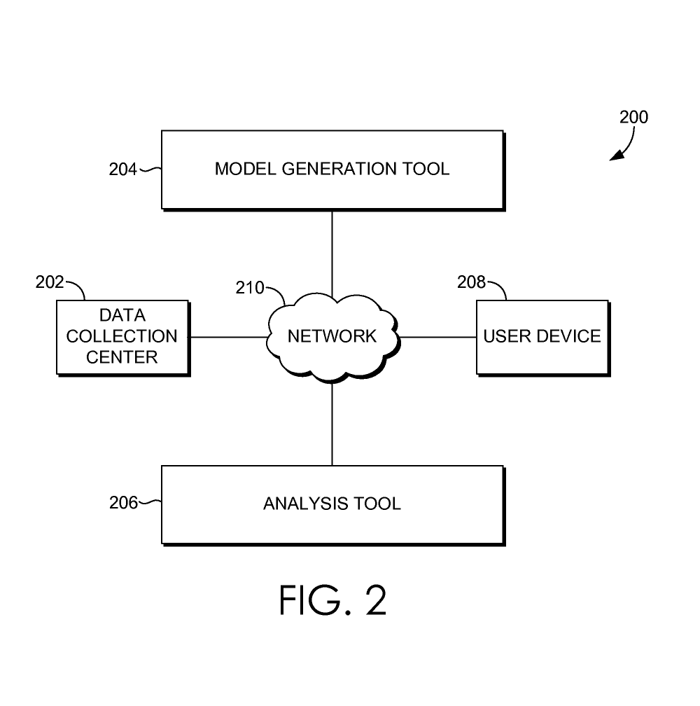

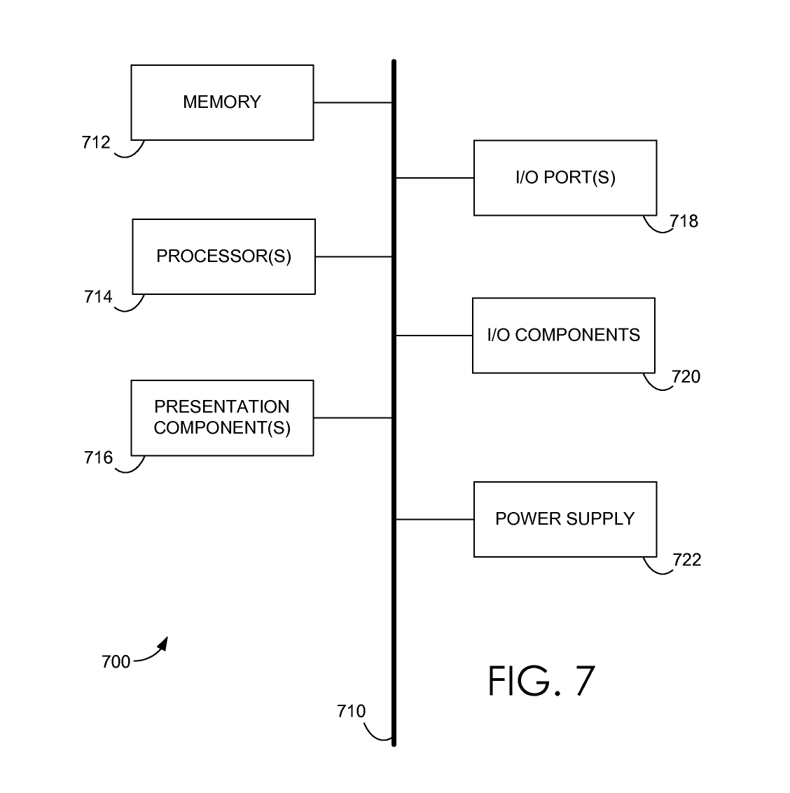

Among other components not shown, the system 200 includes a data collection center 202, a model generation tool 204, an analysis tool 206, and a user device 208. It should be understood that the system 200 shown in FIG. 2 is an example of one suitable computing system architecture. Each of the components shown in FIG. 2 may be implemented via any type of computing device, such as computing device 700 described with reference to FIG. 7, for example. The components may communicate with each other via a network 210, which may include, without limitation, one or more local area networks (LANs) and/or wide area networks (WANs). Such networking environments are commonplace in offices, enterprise-wide computer networks, intranets, and the Internet.

It should be understood that any number of data collection centers 202, model generation tools 204, analysis tools 206, and user devices 208 may be employed within the system 200 within the scope of the present invention. Each may comprise a single device, or portion thereof, or multiple devices cooperating in a distributed environment. For instance, the model generation tool 204 and/or analysis tool 206 may be provided via multiple devices arranged in a distributed environment that collectively provide the functionality described herein. Alternatively, the model generation tool 204 and the analysis tool 206 may be combined as a single forecasting tool to provide the forecasting functionality described herein. As another example, multiple data collection centers 202 may exist, for instance, to be located in remote locations, to increase storage capacity, or to correspond with distinct information (e.g., a separate data collection center for separate websites). Additionally, other components not shown may also be included within the network environment.

The data collection center 202 may collect data from any number of data sources and any type of data sources (e.g., as illustrated in FIG. 1). In some cases, the data sources generally include any online presence at which website usage occurs or can be detected. In such cases, the data collection center 202 may access data from a web server(s) providing a website(s) and/or from a client device(s) at which a website(s) is being browsed or navigated. As can be understood, the data collection center 202 can contain any amount of data including raw or processed data. The collected data can be stored in a storage area, such as a database, for reference by the model generation tool 204, analysis tool 206, and/or user device 208. Any and all such variations of data sources and data associated with the data collection center 202 are contemplated to be within the scope of embodiments of the present invention.

Generally, data collected within the data collection center 104 can represent observed data associated with various features. Data associated with any number or type of features can be collected. For example, data associated with hundreds of features might be collected. A feature generally refers to a variable, covariate, predictor, attribute, factor, regressor, or any other type of data, for example, represented by a column in a data matrix. The particular type(s) of feature collected can be designated in any manner. In some cases, any and all features as designated or selected by a provider of data analysis might be captured. In other cases, features designated by a user might be captured. A user refers to an individual or entity (e.g., an online service provider) to obtain data or reports (e.g., forecasted metrics), for example, provided from a data analysis provider. In some cases, a user may be an individual at a data analysis provider that wishes to obtain a forecasted metric. For example, a user of the user device 208 might designate or select (e.g., via a web service or application) a set of features for which the user is interested in collecting and/or viewing data.

In accordance with various embodiments described herein, the data collected may be in the form of a time series. That is, a time series of data might be collected or captured for any number of observed features. A time series refers to a series of values obtained at successive times, often with equal intervals between them.

The collected data can be represented in the form of one or more matrices or data sets. A matrix or data set can be defined by a set of rows and a set of columns. The rows can represent a time series, or any other type of data. The columns can represent features, for instance, variables, covariates, predictors, attributes, factors, regressors, or any other type of data. By way of example only, in one embodiment, the rows of a matrix represent various time instances or periods (e.g., hours, days, weeks, months, etc.) within a time series, and the columns represent various observed features, for example, pertaining to users, customers, website visits, marketing, etc.

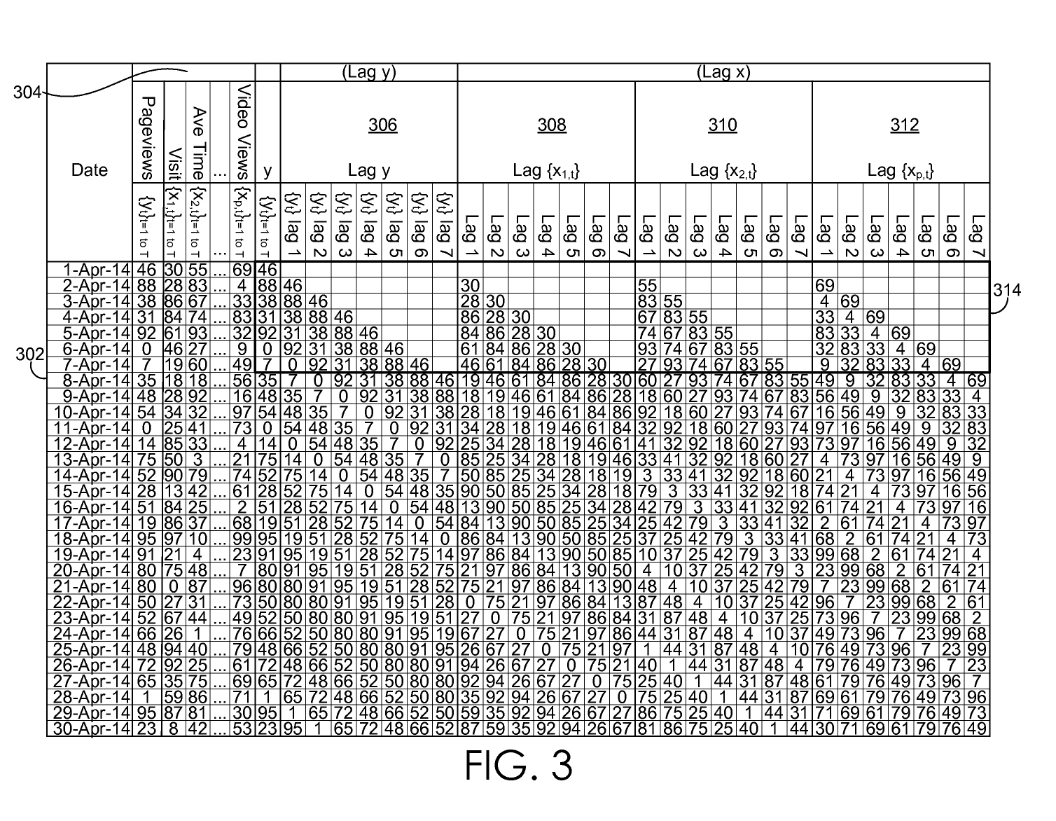

As illustrated in FIG. 3, FIG. 3 is an example data matrix pertaining to web data. The rows 302 of the data matrix represent various components of a time series, namely, dates. The columns 304 represent various features (e.g., page views, visits, average time, video visits) for which observations are collected. Although web data is illustrated in FIG. 3, any type of data is within the scope of embodiments of the present invention. Web data is only one example of data that can be collected and utilized in accordance with embodiments described herein.

Returning to FIG. 2, as can be appreciated, the data collected within the data collection center 202 can be updated or modified at any time in accordance with various implementations. For example, in some embodiments, data can be added to the data set in real-time or as realized by a computing device, such as a web server.

Irrespective of what the values or data entries within a data set represent, the model generation tool 204 generates a forecasting model for a metric of interest using collected data. Forecasting models can be used to generalize or predict an outcome or score for a metric of interest. Stated differently, forecasting models can provide a generalization for a future observation. A metric of interest or target metric can be specified or designated in any number of ways. For example, a target metric (e.g., target web metric) might be selected by a user, such as a marketer of an online service provider. In this way, a marketer may select a target metric(s) via a user interface, for example, a web interface accessed using user device 208. In addition to obtaining a target metric to be forecasted, a forecast horizon can also be obtained. A forecast horizon refers to a future period of time for which a forecast is generated. For example, assume a marketing manager is interested in forecasting a metric for the next day and the data is observed daily. In such a case, the forecast horizon is one such that the specified target metric is predicted for the following day. A forecast horizon can be designated in any number of ways, including via a user selection provided by user device 208.

Forecasting models generally include a set of one or more features that is used to generate an outcome or score. For example, many forecasting models compute an outcome or score by combining features with corresponding weights (coefficients) using a function. Equation 1 below provides an example of a basic form of a model or function:

y=ax+b (Equation 1)

wherein y is a dependent variable for which an outcome is predicted (i.e., target metric), x is a feature (e.g., independent variable), a is a weight or coefficient, and b is an offset (e.g., from a predetermined value, such as zero). As can be appreciated, a model can include any number of features x and corresponding weights a, such that a number of features can be utilized in combination to obtain an estimated outcome of y. Although a linear function (e.g., linear regression) is provided as an example of a forecasting model, embodiments of the present invention are not limited thereto.

In many cases, an observed data set includes a time series of data, as shown by rows 302 in FIG. 3. A time series refers to a sequence of data points. Such data points may be measured at successive points in time spaced at uniform time intervals. As such, in embodiments, a forecasting model may use a multivariate modeling approach. A multivariate modeling approach can be used to identify relationships between features. In this regard, a multivariate modeling approach can be used to select a best subset of explanatory time series out of a large set of time series.

For example, Equation 2 below provides an example of a multivariate forecasting model:

E(yₜ₊₁)=α+β₁*yₜ₋₇+β₂*xₜ (Equation 2)

wherein E(yₜ₊₁) is an expected metric (e.g., revenue) for tomorrow, α is a constant, β represents coefficients, yₜ₋₇ represents the feature to be predicted (e.g., revenue) observed a week ago, and xₜ represents an independent feature observed today (e.g., website visits).

To generate a forecasting model (e.g, in the form of a multivariate forecasting model), initially, the model generation tool 204 can select or identify a particular set of data to analyze from the data collection center 202. In some cases, all of the data within the data collection center 102 might be analyzed to generate a model. In other cases, a portion of the captured data might be analyzed to generate a model. For example, a portion of the features identified by columns might be analyzed. Alternatively or additionally, a portion of the records or observations identified by rows might be analyzed. For instance, an extent of the most recently captured records might be analyzed (e.g., within the month) for purposes of generating a forecasting model. Generating or generation used herein are intended to refer to an initial generation of a forecasting model and/or an updated forecasting model.

A set of observed data to analyze generally includes a time series associated with various features including a time series associated with the metric to be forecasted (i.e., target feature). A target feature refers to a feature (y) having observed data that corresponds with a metric to be forecasted. In this regard, assume that a target metric (e.g., web metric) to be forecasted is number of page views. In such a case, a time series of a target feature (y) includes the data observed associated with number of page views. By way of example, a set of data to analyze may include a time series associated with the target feature or metric to be forecasted, {yₜ}_{t=1 to T}, and time series of other potential features (p), {x_{1,t}, x_{2,t}, . . . , x_{p,t}}_{t=1 to T}. The potential features (p) may be of any number and may include any time series data, for example, from web analytics, social platforms, media, or the like.

In some cases, an initial data set of observed features can be modified to include lag variables as features. A lag refers to a fixed time displacement. As such, a lag feature is a feature associated with lagged data that occurred at a previous time. As can be appreciated, a lag variable or feature includes a value of some other variable as it occurs at some number of periods earlier. In some implementations, a maximum number of lags to consider or analyze can be selected. A maximum number of lags may correspond with a seasonal cycle, for instance, such that at least one seasonal cycle is included in the data set. For instance, for data observed daily, a number of lags, k, might be at least 7 to account for weekly seasonality. In this regard, for each observed feature within the data set, the data set can be modified to include lag variables as features (lag features). Equations 3 and 4 provide exemplary sets of potential features of lag of y and lag of x(s) (other potential features) for use in generating a forecasting model.

Lag y={yₜ₋ₕ, . . . yₜ₋ₕ₋ₖ₊₁}_{t=(h+k) to T}, (Equation 3)

where h is a forecast horizon and k is the maximum number of lags considered.

Lag x={x_{1,t-h}, . . . x_{1,t-h-k+1}, . . . ,x_{p,t-h}, . . . x_{p,t-h-k+1}}_{t=(h+k) to T}, (Equation 4)

where h is a forecast horizon, k is the maximum number of lags considered, and p refers to the potential feature. As a result of applying lags to each of x features, the total number of features resulting is p*k features. For example, assume 1000 initial x features are observed and the maximum number of lags k is determined to be seven to account for a weekly cycle of data. In such a case, upon expanding the potential features to incorporate lags of the features, the total number of potential features equals 7000 (i.e., 1000*7).

By way of example, and with reference to FIG. 3, an initial data set includes a set of observed features 304 having observed data captured for a time series 302. Assume that a lag of seven days is desired to account for weekly seasonality. As such, for each of features y, x1, x2 . . . xp, seven lags of each feature are identified and captured. As illustrated in FIG. 3, 306 represents seven lags for feature y (i.e., target feature), 308 represents seven lags for feature x₁, 310 represents seven lags for feature x₂, and 312 represents seven lags for feature xₚ. As can be appreciated, any number of potential features p can be collected and used to build a forecasting model. Further, any number of lags k can also be used to modify the set of observed features. In some cases, data values may be missing upon applying the various lags. For instance, as illustrated in FIG. 3, data is missing for the first seven days listed in the time series. As such, those data points (i.e., designated by box 314) may be removed altogether from the time series for purposes of processing the data to generate a forecasting model.

The model generation tool 204 can use the modified set of features to perform feature selection. Feature selection, which may also be referred to as metric selection or variable selection, refers to selecting a subset of relevant features for use in model construction. Reducing the number of features to construct forecasting models can improve, for example, model interpretability and increase forecasting accuracy.

One exemplary feature selection technique that can be used to perform feature selection to reduce the number of features is the Least Absolute Shrinkage and Selection Operator (LASSO) method for constructing a linear model. LASSO penalizes the regression coefficients, shrinking many of them to zero. Any features having non-zero regression coefficients are selected by the LASSO algorithm. LASSO can be used to overcome multicollinearity, which may be an issue with using time series data because time series can be highly correlated with each other due to same external factors, such as seasonality, economic environment, etc., that may affect multiple time series. The application of LASSO is generally known in the art and, as such, is not described in detail herein.

In applying LASSO, an order or ranking of feature results in terms of importance of the features. In some cases, an incremental LASSO method can be used to perform feature selection such that not all of the features are included in generating the forecasting model. An incremental approach iteratively evaluates a candidate subset of features. To this end, an initial set of features is compared to a modified set of features to evaluate if the modified subset is an improvement over the initial set of features. Generally, evaluation of the subsets includes utilization of a scoring metric for the subset of features. The subset of features with the highest score discovered up to that point is selected as the satisfactory feature subset, and the process continues until a stopping point is reached. Stopping criteria to terminate the iterative process can vary by algorithm, but may include a subset score exceeding a threshold, a surpassing of a permitted run time, etc.

Although various stopping criteria can be used, a model selection criteria is described herein to determine a stopping point. In this manner, initially, a forecasting model can be generated using only a constant, that is, without any features. A model selection criteria can be calculated for this model. For example, Akaike Information Criteria (AIC) or Bayesian Information Criteria (BIC) can be used. Assume that BIC is applied to generate BICₐ for the initial forecast model with only a constant. Using the ranking of features provided from LASSO, the highest ranked feature can then be added to the forecast model to generate a new forecast model. Assume that BIC is applied to the new forecast model to generate BIC_{b} for the new forecast model. The model selection criteria (BICₐ and BIC_{b}) can then be compared to one another. If BIC_{b} is less than BICₐ, then BICₐ=BIC_{b}. That is, BIC_{b} becomes BICₐ with the current feature being included in the set of selected features, and the process returns to add the next best feature (e.g., as ranked via LASSO) from which a new BIC_{b} is calculated and compared to BICₐ. This iterative process continues until BIC_{b} is greater than or equal to BICₐ. When BIC_{b} (the value associated with the additional feature) is greater to or equal to BICₐ, the stopping point is identified. The features used to calculate BICₐ are then used as the selected set of features. Generally, a lower value of BIC indicates a better fitting model. Although LASSO is described in detail herein to reduce and select an appropriate set of features, any feature selection technique (e.g., time series feature selection technique) can be used to rank and select a set of features.

In addition to performing feature selection (e.g., via the incremental LASSO approach) to select a subset of features from among the modified set of features, feature selection can also be performed using only the target features. In this way, the incremental LASSO approach described above can be applied to feature lags associated with the metric (y) to be forecasted, illustrated as features 306 in FIG. 3. As such, a subset of the target features (y) can be selected.

Upon identifying a reduced set of features, embodiments of the present invention employ causality-based feature selection to identify the specific features to utilize in generating a forecasting model. As described above, two subsets of features are identified, for example, using a feature selection technique, such as LASSO. A first subset of features may include only a target feature(s) (y), while a second subset of features may include a target feature(s) (y) and a potential independent feature(s) (x). Using the first subset of target features, a first forecasting model M₁ can be generated. In this regard, a forecasting model M₁ can be generated using LASSO feature selection for regression y on lag y feature(s). For instance, assume that yₜ₋₁ and yₜ₋₇ are lag target features selected based on LASSO feature selection. In such a case, equation 5 below provides an example of the forecasting model M₁.

M₁ is yₜ=a+b₁*yₜ₋₁+b₂*yₜ₋₇ (Equation 5)

Using the second subset of features, a second forecasting model M₂ can be generated. A forecasting model M₂ can be generated using LASSO feature selection for regression residual using lag y and lag x features. M₂ is obtained by performing LASSO feature selection on lag y and lag x features. The features selected based on LASSO may or may not contain any lag y feature. By way of example only, assume that X_{5,t-1} and x_{9,t-7} are lag variables selected based on LASSO feature selection. In such a case, equation 6 below provides an example of a forecasting model M₂.

M₂ is dyₜ=c+d₁*x_{5,t-1}+b₂*x_{9,t-7} (Equation 6)

wherein dyₜ=yₜ−(a+b₁*yₜ₋₁+b₂*yₜ₋₇). (Equation 7)

In embodiments described herein, a Granger Causality comparison can be applied to determine whether the subset of features used in forecasting model M₁ or the subset of features used in forecasting model M₂ should be utilized to generate the forecasting model. Granger Causality can be used to avoid selection of features spuriously correlated to the target metric. Generally, Granger Causality tests whether a cause (change in x) happened prior it is effect (change in y) and a cause (x) had unique information about the future values of its effect (y). The test can be formulated as a test of equality of two forecasting models, namely, a forecasting model including only lags of the target feature (y) and a forecasting model including lags of the target feature (y) and additional potential features (x).

In some implementations, to compare the models using Granger Causality, a model selection criteria can be calculated for each of the forecasting models, M₁ and M₂. For example, Akaike Information Criteria (AIC) or Bayesian Information Criteria (BIC) can be used. Assume that BIC is applied to generate BIC(M₁) and BIC(M₂). If BIC(M₁) is less than or equal to BIC(M₂), then the selected subset of features to generate a forecasting model are the features provided in M₁. On the other hand, if BIC(M₁) is greater than BIC(M₂), then the selected subset of features to use to generate a forecasting model are the features provided in M₂. In this case, the selected features are causally, and not spuriously, correlated with the target metric.

Upon identifying a set of features for use in forecasting, a forecasting model can be generated. In some case, the selected model (M₁ or M₂) can be the generated forecasting model used to predict a metric of interest. Any approach, however, can be used to build or generate a forecasting model using the selected feature set. For example, another model using multiple regression can be generated using the selected set of features.

In some implementations, the model generation tool 204 can track or monitor the forecasting model to detect any updates to the forecasting model that might be needed. New data captured, for example, via a data collection center, can be used to examiner whether to update a forecasting model. Using at least a portion of the new data, a forecasting model F₁ can be generated using the features most recently selected. In some cases, the previously generated forecasting model may be used as the forecasting model F₁. At least a portion of the new data can also be used to build a new forecast model F₂ as described above. That is, a combination of LASSO feature selection and Granger Causality can be applied to the new data to select features to generate a new forecast model F₂. As such, the forecasting model F₁ and F₂ can include different subsets of features.

In some implementations, to compare the models, a model selection criteria can be calculated for each of the forecasting models, F₁ and F₂. For example, Akaike Information Criteria (AIC) or Bayesian Information Criteria (BIC) can be used. Assume that BIC is applied to generate BIC(F₁) and BIC(F₂). If BIC(F₁) is greater than and/or exceeds a predetermined threshold value as compared to BIC(F₂), then the new forecasting model F₂ can be selected for utilization. Otherwise, utilization of forecasting model F₁ can be maintained. As can be appreciated, other methods can be employed to compare forecasting models and determine whether to update the forecasting model.

The model generation tool 204 can perform model generation operations in real time (e.g., as data is recorded at the data collection center), in a batch methodology (e.g., upon a lapse of a time duration), or upon demand, for instance, when a request is made for marketing analytics. By way of example only, in some cases, the model generation tool 204 automatically initiates model generation, for instance, based on expiration of a time duration, upon recognition of new data, or the like. As another example, a user operating the user device 208 or another device might initiate model generation, either directly or indirectly. For instance, a user may select to run a “model generation update” to directly initiate the model generation tool 204. Alternatively, a user may select to view a marketing or conversion analysis or report, for example, associated with website usage or advertisement conversion, thereby triggering the model generation tool to generate or update a forecasting model. A user might initiate the functionality request directly to the data collection center 202 or model generation tool 204, for example, through a marketing analytics tool.

Although the model generation tool 204 is shown as a separate component, as can be understood, the model generation tool 204, or a portion thereof, can be integrated with another component, such as a data collection center, an analysis tool, a user device, a web server, or the like. For instance, in one embodiment, the model generation tool 204 is implemented as part of a marketing analysis server or other component specifically designed for marketing analysis. In another embodiment, the model generation tool 204 is implemented as part of a web server or other hardware or software component, or it can be implemented as a software module running on a conventional personal computer, for example, that is being used for marketing analysis.

Turning now to the analysis tool 206, the analysis tool 206 is configured to utilize a forecasting model, such as a forecasting model generated by the model generation tool 204, to analyze and predict data. The analysis tool 206 can use a forecasting model to predict a particular outcome or target. For example, a forecasting model might predict likelihood for a conversion of a displayed advertisement to a sale of a product. Forecasting models are invaluable in many environments. For example, in an exemplary environment of marketing analytics, predicting outcomes is desirable for any number of analyses performed on products and/or services, for example, associated with a website. Marketing analytics can include, for example, capturing data pertaining to conversions, revenues, or website visits. In this regard, a variety of data can be identified including user data (e.g., user demographics, user location, etc.), links selected on a particular web page, advertisements selected, advertisements presented, conversions, type of conversion, etc. Although marketing analytics is one environment in which embodiments of the present invention may be implemented, any other environment in which forecasting models are generated may benefit from implementation of aspects of this invention.

In accordance with obtaining data or input, the analysis tool 206 can use a forecasting model to predict a particular outcome or target. To this end, the analysis tool 206 can reference the data or input. Such data can be referenced (e.g., received, retrieved, accessed, etc.) from the data collection center 202 or other component. As can be appreciated, the data may be referenced in real-time, that is, as it is produced or collected, such that a prediction can be immediately determined and provided for use in real-time. Upon referencing the data, values associated with the features of the selected forecasting model may be obtained or calculated.

The identified values of features can be inserted into the forecasting model for use in predicting an outcome or target. By way of example only, assume that a forecasting model includes feature X_{5,t-1}. Further assume that x₅ is the number of visitors visiting a website and t=Jun. 5, 2014. In such a case, X_{5,t-1}, the number of visitors on the website on Jun. 4, 2014, is referenced and used in the forecasting model to generate a prediction of a target metric. As can be appreciated, any number of features might be used within a forecasting model to predict an outcome y.

Estimated outcomes, y, or other data can be provided to the user device 108 or other device. As such, a user of the user device 108 can view data predictions and other corresponding data. In this regard, a data analysis performed using a forecasting model generated using causality based feature selection can be presented to a user, for example, in the form of a data report. For instance, in an advertising analytics environment, reports or data associated with contextual targeted advertising can be provided to a user of a marketing analytics tool. Additionally or alternatively, a user visiting a website might be presented (e.g., via a user device) with a more appropriate or effective advertisement(s) as the forecasting model provides data indicating target advertisements contextually relevant to the user.

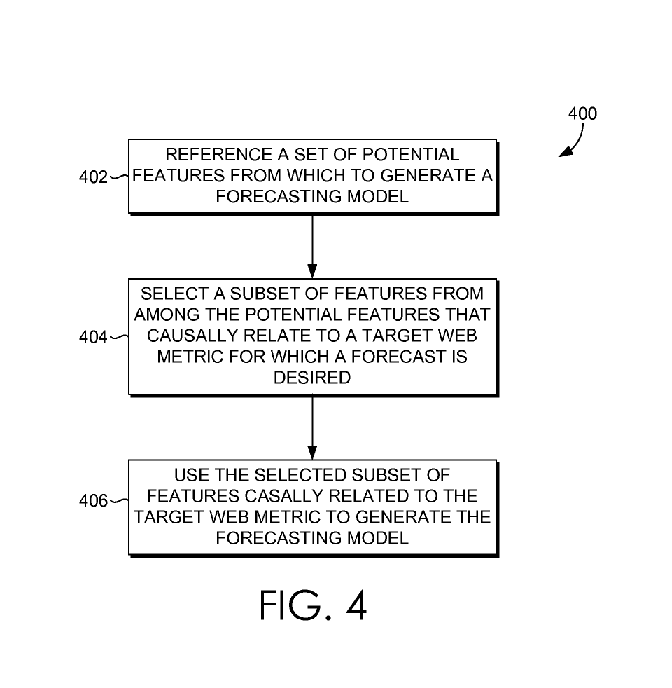

Turning now to FIG. 4, an exemplary flow diagram illustrating a method 400 for generating forecasting models using causality-based feature selection is generally depicted. In embodiments, the method 400 is performed by the model generation tool 204 of FIG. 2, or other component(s) performing like functionality. Initially, at block 402, a set of potential features from which to generate a forecasting model is referenced. In embodiments, the set of potential features may include lag features or lag variables. The lag features can be associated with a target feature (y) as well as other features (x) for which data is observed. At block 404, a subset of features from among the potential features is selected that causally relate to a target web metric for which a forecast is desired. The subset of features can be selected, for instance, using Granger Causality. In some cases, a feature selection technique, such as LASSO, may be applied to select or reduce the feature set prior to applying Granger Causality. Thereafter, at block 406, the selected subset of features causally related to the target web metric is used to generate the forecasting model. Such a forecasting model is used to forecast an outcome associated with the target web metric.

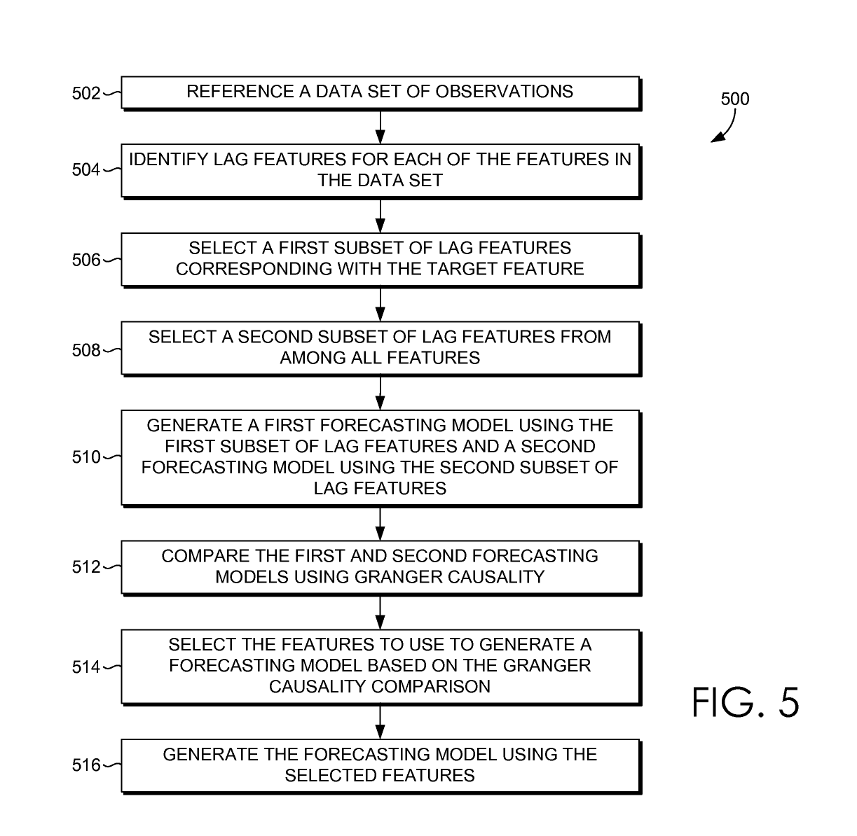

With reference now to FIG. 5, an exemplary flow diagram illustrating another method 500 for generating forecasting models using causality-based feature selection is generally depicted. In embodiments, the method 500 is performed by the model generation tool 204 of FIG. 2, or other component(s) performing like functionality. Initially, at block 502, a data set of observations is referenced. The data set may include any number of features as well as any number of observations. At block 504, lag features are identified for each of the observed features in the data set in accordance with a maximum number of lags to be considered. The maximum number of lags may be selected, for example, by a user via a user device to accommodate seasonality of the data. At block 506, a first subset of lag features corresponding with the target feature are selected. At block 508, a second subset of lag features from among all the lag features are selected. In some embodiments, LASSO may be used to select the subset of lag features selected at block 506 and 508. In particular, an incremental LASSO approach can be used to select an appropriate feature set. At block 510, a first forecast model is generated using the first subset of lag features corresponding with the target feature, and a second forecast model is generated using the second subset of lag features from among all the lag features. The first forecast model and the second forecast model are compared using a Granger Causality comparison, as indicated at block 512. The features to utilize in generating the forecasting model are selected based on the Granger Causality comparison. This is indicated at block 514. At block 516, the forecasting model is generated using the selected features.

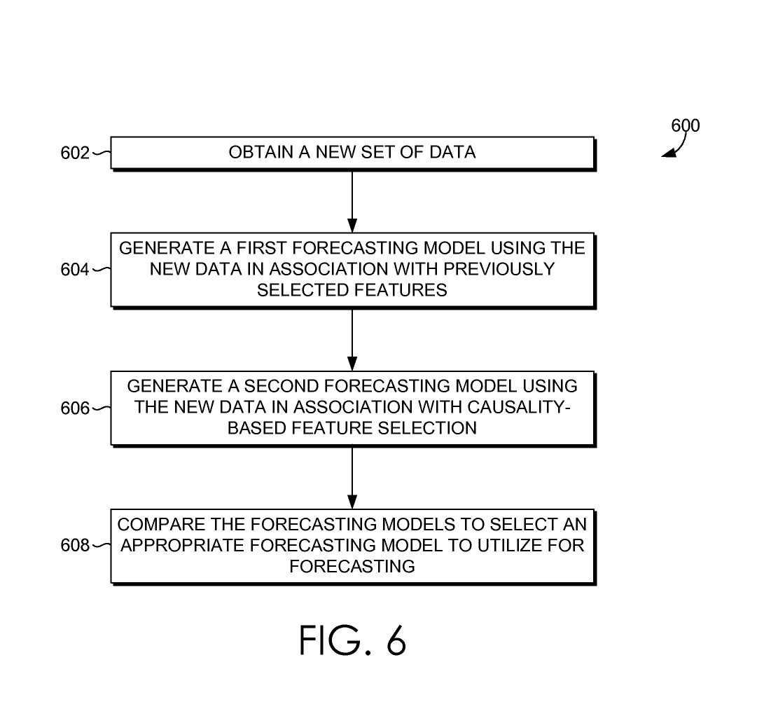

Turning now to FIG. 6, an exemplary flow diagram illustrating a method 600 for tracking a forecasting model is generally depicted. In embodiments, the method 600 is performed by model generation tool 204 of FIG. 2, or other component(s) performing like functionality. Initially, at block 602, a set of new data is obtained. At block 604, a first forecasting model is generated using at least a portion of the new data in association with previously selected features. At block 606, a second forecasting model is generated utilizing at least a portion of the new data in association with causality-based feature selection, as described herein. Thereafter, at block 608, the forecasting models are compared to one another to select the appropriate forecasting model to use for forecasting. In embodiments, the forecasting models are compared using a model selection criterion, such as BIC.

Having described an overview of embodiments of the present invention, an exemplary computing environment in which some embodiments of the present invention may be implemented is described below in order to provide a general context for various aspects of the present invention.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

Accordingly, referring generally to FIG. 7, an exemplary operating environment for implementing embodiments of the present invention is shown and designated generally as computing device 700. Computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

With reference to FIG. 7, computing device 700 includes a bus 710 that directly or indirectly couples the following devices: memory 712, one or more processors 714, one or more presentation components 716, input/output (I/O) ports 718, input/output components 720, and an illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterates that the diagram of FIG. 7 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer-storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as, stereoscopic camera systems, infrared camera systems, RGB camera systems, and combinations of these for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

As can be understood, embodiments of the present invention provide for, among other things, forecasting metrics using causality based feature selection. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations comprising:
referencing a set of potential features from which to generate a forecasting model, the set of potential features comprising lags of features and corresponding with data collected in association with website usage;
selecting a subset of features, from among the potential features, that causally relate to a target web metric for which a forecast is desired;
using the selected subset of features causally related to the target web metric to generate the forecasting model; and
computing an outcome associated with the target web metric that is expected to occur at a future time using the forecasting model generated in connection with the selected subset of features causally related to the target web metric.

2. The one or more computer storage media of claim 1, wherein the set of potential features include a lags of a target feature.

3. The one or more computer storage media of claim 1, wherein a number of lag features associated with each observed feature is selected based on seasonality associated with a time series.

4. The one or more computer storage media of claim 1, wherein the forecasting model comprises a time series forecasting model.

5. The one or more computer storage media of claim 1, wherein the subset of features are selected using a Granger Causality concept.

6. The one or more computer storage media of claim 5, wherein the subset of features are selected using Least Absolute Shrinkage and Selection Operator (LASSO) feature selection to reduce the set of potential features to utilize in applying the Granger Causality concept.

7. The one or more computer storage media of claim 1 further comprising obtaining the collected data from a plurality of data sources.

8. The one or more computer storage media of claim 1, further comprising receiving a selection of the target web metric for which to generate the forecasting model.

9. A computerized method comprising:
selecting, by a first computing process, a first subset of features from among a first set of lag features corresponding with a metric to be forecasted;
selecting, by a second computing process, a second subset of features from among a second set of lag features, the second set of lag features including the first set of lag features and lag features associated with additional observed features;
generating, by a third computing process, a first forecasting model using the first subset of features and a second forecasting model using the second subset of features; and
comparing, by a fourth computing process, the first forecasting model and the second forecasting model using Granger Causality to determine selection of the first subset of features or the second subset of features to use to generate a forecasting model, wherein the first, second, third, and fourth computing processes are performed by one or more computing processors.

10. The method of claim 9, wherein the additional observed features comprise independent features that are not being forecasted.

11. The method of claim 9, wherein the first subset of features is selected using Least Absolute Shrinkage and Selection Operator (LASSO) feature selection.

12. The method of claim 9, wherein the second subset of features is selected using Least Absolute Shrinkage and Selection Operator (LASSO) feature selection.

13. The method of claim 9 further comprising calculating a first Bayesian information criterion (BIC) for the first forecasting model and a second Bayesian information criteria (BIC) for the second forecasting model.

14. The method of claim 13, wherein the first Bayesian information criteria (BIC) for the first forecasting model is compared to the second Bayesian information criteria (BIC) for the second forecasting model to determine selection of the first subset of features or the second subset of features to use to generate the forecasting model.

15. The method of claim 9 further comprising using the selected first subset of features or the second subset of features to generate the forecasting model.

16. The method of claim 15 further comprising using the forecasting model to forecast the target metric.

17. One or more computer storage media storing computer-useable instructions that, when used by one or more computing devices, cause the one or more computing devices to perform operations comprising:
generating a first time series forecasting model using at least a portion of new observed data in association with one or more features previously selected for use in generating a forecasting model;
generating a second time series forecasting model using at least a portion of the new observed data in association with causality-based feature selection;
comparing the first time series forecasting model and the second time series forecasting model to one another to select one of the first time series forecasting model or the second time series forecasting model to use to forecast a target metric; and
utilizing the selected time series forecasting model to forecast the target metric.

18. The one or more computer storage media of claim 17, wherein the first and second time series forecasting models are compared using a first model selection criteria for the first time series forecasting model and a second model selection criteria for the second time series forecasting model.

19. The one or more computer storage media of claim 17, wherein the first model selection criteria comprises a first Bayesian information criteria (BIC), and the second model selection criteria comprises a second Bayesian information criteria (BIC).

20. The one or more computer storage media of claim 19, wherein the second time series forecasting model is selected when the first Bayesian information criteria (BIC) of the first time series forecasting model exceeds a threshold compared to the second Bayesian information criteria (BIC) of the second time series forecasting model.
